(19) United States
(12) Patent Application Publication
(10) Pub. No.: US 2023/0100238 A1
(43) Pub. Date: Mar. 30, 2023

(54) METHODS AND SYSTEMS FOR DETERMINING THE 3D-LOCATIONS, THE LOCAL REFERENCE FRAMES AND THE GRASPING PATTERNS OF GRASPING POINTS OF AN OBJECT

(71) Applicant: TOYOTA MOTOR EUROPE, Brussels (BE)

(72) Inventors: Norimasa KOBORI, Brussels (BE); Luca MINCIULLO, Brussels (BE); Gianpiero FRANCESCA, Brussels (BE); Lorenzo GARATTONI, Brussels (BE)

(73) Assignee: TOYOTA MOTOR EUROPE, Brussels (BE)

(21) Appl. No.: 17/768,058

(22) PCT Filed: Oct. 11, 2019
(86) PCT No.: PCT/EP2019/077656

§ 371 Date: Apr. 11, 2022

(51) Int. Cl. G06T 7/73

(52) U.S. Cl. CPC G06T 7/73; G06T 2207/20084

(57) ABSTRACT

A grasping points determination method including: S10) receiving a scene image showing an object to be grasped; S20) in the scene image, determine the object and its features, and local descriptors and 2D-locations of these features; S30) based on database local descriptors of features of the object and 2D- and 3D-location(s) of grasping points of the object, determined in a previous position of the object, identifying a best-fit combination which transforms previously defined local descriptors into the determined local descriptors; S40) determining the registration corresponding to the combination; S50) determining in the scene image 2D-location(s) of grasping points by applying registration to previously defined 3D-location(s) of the grasping points; S60) determining 3D information relative to the object; S70) determining 3D-location(s) of the grasping points. Grasping points database creation method for creating the database. Systems for implementing the above methods.

### FIELD OF THE DISCLOSURE

The present disclosure first concerns methods and systems for learning, for an object which has to be grasped, the 3D-locations, the local reference frames and the grasping patterns of the grasping points of an object.

Herein, a grasping point is a point of an object at which it is preferable to grasp the object in order to manipulate it, for instance by hand, or with a robotic arm.

A local reference frame is an ordered triplet of vectors perpendicular to each other, defining an orientation of a solid body at a point in space; for instance, defining a local orientation of the object at a grasping point.

A grasping pattern for a grasping point is a datum of information describing a trajectory that must be followed by a finger (or more generally, any body suitable for grasping the object, such as a human finger, a robotic arm, etc.) in order to get a contact point of the finger to come into contact with the object at the grasping point. Preferably, the grasping pattern includes information, at each position on the trajectory, on the local reference frame at the contact point of the finger (which means, that the grasping pattern includes information on the orientation of the finger, at least at its contact point, at each point of the trajectory). A grasping pattern can for instance be expressed in terms of 6D-positions of the finger (or at least, of its contact point) at all points of the trajectory.

By extension, the present disclosure is further directed to methods and systems for determining, in view of an object which has to be grasped, the grasping points and grasping patterns of the object.

### BACKGROUND OF THE DISCLOSURE

While grasping objects may appear as an easy task for a human being, it is conversely quite difficult to achieve for a robot. One of the difficulties is to determine how to grasp an object to be manipulated. To determine how to perform such action, a first step is to determine the points of the object, or “grasping points”, at which the object is to be grasped.

A method for acquiring grasping points, using deep learning, is proposed by publication [1] below. However, such method is not flexible, since the neural network has to be retrained each time a new type of object is added to the list of objects for which grasping points have to be identified.

[1] Deep Learning for Detecting Robotic Grasps, Ian Lenz, Honglak Lee, Ashutosh Saxena. International Journal of Robotics Research (IJRR), 2014.

Accordingly, a first purpose of the present disclosure is to propose a method and system for identifying grasping points of an object, making it possible to identify such grasping points for a large variety of objects, in a robust manner and relatively fast. An additional purpose of the present disclosure is to propose a method and system for identifying the local reference frame and the grasping pattern, for each grasping point that has been identified.

### SUMMARY OF THE DISCLOSURE

According to a first aspect of the present disclosure, in accordance with the first purpose of the disclosure, a grasping points database creation method is proposed. This method comprises:

S110) receiving an object image showing an object;
receiving a grasping image showing the object being grasped at at least one grasping point;
the object image and the grasping image being acquired from the same point of view relative to the object;
   S120) based on the object image:
detecting the object and features of the object, and
determining local descriptors and 2D-locations of said features of the detected object;
a local descriptor for a feature of an object detected in an image being a datum including a 2D-location of the feature in the image, and feature information (HG) characterizing the feature;
   S130) determining in the grasping image 2D-location(s) of said at least one grasping point of the detected object;
   S140) determining 3D information relative to the object;
   S150) determining 3D-location(s) of the at least one grasping point (GP_{OD1}) for the object, based on the 2D-location(s) of the at least one grasping point determined at step S130 and the 3D information relative to the object; and
   S170) storing in the database a grasping points record relative to the object, comprising the determined local descriptors and the determined 2D-locations of the features of the detected object, and the 2D- and/or 3D-location(s) of the at least one grasping point for the object.

If only 2D- (not 3D-) locations are recorded for the grasping points, in this case preferably sufficient information is also stored in the grasping points record to make it possible to calculate the 3D-locations of the grasping point(s), based on the stored information.

In the above-defined method, the 2D-locations of the grasping point(s) of the object, which are stored optionally as a part of the object grasping points record, are based of course on a single original point of view. That is, they are all defined for a single point of view relative to the object, which is the point of view from which the scene image was acquired.

In the above definition, the object image is an image showing the object. Preferably, the object image shows the whole object, without any part of it being occluded.

The 2D-location of a feature of an object in an image usually corresponds to the center (or center of gravity) of the feature in a sub-image of the image showing the detected feature. As an alternative, the origin of the 2D-location can be a corner of the bounding box of the sub-image, or any equivalent information.

This 2D-location can also be the bounding box of the sub-image corresponding to the feature in the image, or any equivalent information.

The grasping image can show the object being grasped by different means: by hand, by a robotic claw, and more generally by any grasping means.

In an embodiment, which is implemented for the case where the grasping image shows a hand grasping the object, at step S130, the 2D-location(s) of said at least one grasping point of the detected object are determined by determining a pose of the hand.

In the above-defined method, the local descriptor can take up different forms. The local descriptor can be the sub-image of the image, showing the detected feature. As an alternative, the local descriptor can be any other characterizing information based on said sub-image of the image, which can be used to track the feature across different images of the object. For instance, the local descriptor can be a histogram showing intensity gradients in the sub-image, or any other information datum, suitable for characterizing a feature represented in the sub-image. The feature information can be for instance the ‘SIFT feature’ (Scale Invariant Feature Transform'). A method for extracting feature information and obtaining local descriptors is for instance disclosed by publication “Distinctive Image Features from Scale-Invariant Keypoints”, from David. G. Lowe, International Journal of Computer Vision, 91-110, 2004.

In the above-defined method, 3D information is determined at step S140. This 3D information relative to the object can be obtained by any known method. For instance, it can be acquired using stereovision, and/or based on information provided by a 3D measurement device capable of determining 3D- or depth information for the detected object.

The ‘3D information’ relative to the object refers to a 3D-model of a part or of the whole object. The 3D information can take up different forms: a depth map, a point of clouds, or a mesh of triangles, for instance. The 3D information should preferably contain 3D information at least in the vicinity of each grasping point of the object.

In the above-defined method, the 3D-location(s) of the grasping point(s) are determined. These 3D-locations can be determined, in particular, by projecting (virtually), using the 3D information relative to the object, the 2D-locations of the grasping points as determined at step S130 on the surface of the object. For instance, the 3D location of a grasping point can be determined as being the intersection between a straight line passing by the optical center of the camera (supposed to be in the same position as when the object and grasping images were acquired) and the 2D-location of the grasping point, and a surface of the object as defined by the 3D information or 3D model of the object. This amounts to project onto the surface of the object the point of the camera image where the grasping point appears in the grasping point image.

In an embodiment, the method further comprises a step S160 wherein a normal, a local reference frame, and/or a grasping pattern of said at least one grasping point of the object is or are determined.

The local reference frame at a grasping point being considered can be for instance the triplet of vectors comprising: A first vector which is the normal vector X at the grasping point; a second vector, which is the horizontal vector Y passing through the grasping point; and a third vector, which is the vector product of the first and second vectors.

As it will be explained below, local descriptors can be used efficiently to determine the actual 3D-location, local reference frame and grasping pattern of grasping points of an object detected in images, by using the database obtained thanks to the above-proposed method.

According to a second aspect of the present disclosure, a grasping points and grasping patterns database creation system is proposed to carry out the above method.

This system comprises one or more processors and a memory. The memory stores instructions, which when executed by the one or more processors, cause the at least one processor to:
receive an object image showing an object;
receive a grasping image showing the object being grasped at at least one grasping point;
   the object image and the grasping image being acquired from the same point of view relative to the object;
based on the object image:
   detect the object and features of the object, and
   determine local descriptors and 2D-locations of said features of the detected object;
determine in the grasping image 2D-location(s) of said at least one grasping point of the detected object;
determine 3D information relative to the object ;
determine 3D-location(s) of the at least one grasping point for the object, based on the 2D-location(s) of the at least one grasping point determined at step S130 and the 3D information relative to the object; and
store in the database a grasping points record relative to the object, comprising the determined local descriptors, the determined 2D-locations of the features of the detected object, and the 2D- and/or 3D-location(s) of the at least one grasping point for the object.

In an embodiment, the instructions stored in the memory, when executed by the at least one processor, cause the system to determine a normal, a local reference frame, and/or a grasping pattern of said at least one grasping point of the object.

In an embodiment, which is implemented for the case where the grasping image shows a hand grasping the objects, the instructions stored in the memory, when executed by the at least one processor, cause the system to determine the 2D-location(s) of said at least one grasping point of the detected object by determining a pose of the hand.

In addition to the above proposed method and system, which make it possible to acquire information including the 3D-locations of grasping points of objects, based on images on which the grasping points appear, methods and systems for determining the locations of grasping points of an object are also proposed.

According to a third aspect of the present disclosure, a grasping points determination method is proposed for such tasks.

This method comprises:

S10) receiving a scene image showing an object to be grasped in a scene;
S20) based on the scene image:
detecting the object to be grasped and features of the object;
determining local descriptors and 2D-locations of said features of the detected object;
   S30) based on a database comprising a grasping point record for the object, said grasping point record containing:
database local descriptors and 2D-locations of features of the object; and
database 3D-location(s) of at least one grasping point of the object,
   identifying at least eight pairs of local descriptors, each pair being composed of a selected local descriptor of the database and a corresponding selected local descriptor among the local descriptors determined at step S20, for which a distance between a database local descriptor and a determined local descriptor is minimal;
      S40) determining a registration which transforms the selected database local descriptors into the corresponding selected local descriptors;
      S50) determining in the scene image 2D-location(s) of at least one grasping point for the object by applying the registration to database 3D-location(s) of the at least one grasping points of the object;
      S60) determining 3D information relative to the object;
      S70) determining 3D-location(s) of the at least one grasping point for the object, based on the 2D-location(s) of the at least one grasping point in the scene image determined at step S50 and the 3D information relative to the object.

As in the database creation method, the 3D information relative to the object can be obtained by any method. For instance, this 3D information can be obtained using stereovision and/or using a 3D measurement device capable of determining depth information for the object. This 3D information can be for instance a depth map, including depth information for each point of the object shown in the scene image.

In step S30 of the above-proposed method, the optimal pairs of local descriptors, which exhibit minimum distance (i.e., maximum similarity) between a database local descriptor of the grasping points record of the database and a corresponding local descriptor determined at step S20 for the detected object, are determined. Once these optimal pairs of local descriptors have been found, they define a correspondence between a subset of local features previously identified for the object, stored in the database in the grasping points record, and a set of corresponding local features, selected among the local features determined at step S20.

At step S40, the registration which transforms the local descriptors of the grasping points record and the corresponding local descriptors determined at step S20 is determined. A registration defines a change of coordinate systems. In the present case, the registration determined at step S40 defines the change of coordinate system (i.e., a combination of a rotation and a translation) which moves the object from the position it has based on the grasping points record, to the position it has relative to the camera in the scene image.

In order to make it possible to determine this registration, at least eight pairs of corresponding local descriptors must be identified. Each of these pairs associates a local descriptor of the object, as found in the database, with a corresponding local descriptor of the detected object as determined at step S20. Consequently, as known per se, it is then possible to determine the registration with causes the object to move from its position which corresponds to the grasping point record of the database, to the position it occupies in the scene image.

In an embodiment, the pairs of corresponding local descriptors are identified at step S30 using successively the nearest neighborhood algorithm and the RANSAC method.

In this embodiment indeed, in a first operation, pairs of local descriptors (one local descriptor from the database, and one local descriptor identified in the scene image) which correspond to each other are determined. This determination is made using the nearest neighbourhood method: First, the data stored in the database is stored in a K-Dimensional (K-D) tree; then, using the K-D tree, a search for nearest neighbours of the identified local descriptors is made. This search brings a certain number of pairs of local descriptors.

Then, in a second operation, the RANSAC algorithm is used to remove outliers from these selected pairs of local descriptors. In the present case, all the correct corresponding 2D-locations in the two images (i.e., the image of the database from which the grasping points record is derived and the scene image are on the epipolar geometry plane. Conversely, the outlier data are not on the epipolar geometry plane. Consequently, the outlier data can be found with the RANSAC algorithm, which randomly picks up data points and tests whether they respect or not the geometry constrain. By filtering the data in this manner, the correct corresponding points between the image used for the grasping points record of the database and the current image (the scene image) can be selected.

Lastly, in a third operation, the registration which transforms the local descriptors of the database, as selected at the second operation, into the corresponding local descriptors of the scene image, also selected at the second operation, is determined. This registration is calculated as known per se using the 8-point algorithm, or an equivalent algorithm.

Advantageously, the above-method for determining the registration is fast and provides quite satisfactory results.

Advantageously, the information which can be obtained by the proposed method is not limited to the 3D-locations of the grasping points.

Indeed in an embodiment, the method further comprises a step S80 wherein a normal vector, a local reference frame and/or a grasping pattern at the at least one grasping point, is or are determined.

The local reference frame at a grasping point under consideration (for instance, a triplet (X′,Y′,Z′), where each of X′, Y′ and Z′ is a 3D vector) can for instance be calculated as follows, on the basis of the local reference frame (X,Y,Z) of said grasping point, as stored in the database in the grasping points record.

The registration determined at step S40 (defined by a rotation (rotation matrix rot (size 3*3) and a translation vector h (size 3*1)) is applied to the local reference frame (X,Y,Z) of the grasping point in the database.

The local reference frame (X′,Y′,Z′) for the grasping point under consideration is therefore obtained as follows:

X′=rot*X+h; Y′=rot*Y+h; Z′=rot*Z+h

To implement the above method, a grasping points determination system is further proposed. This system is thus a system for determining 3D-locations of grasping points of objects.

This system comprises one or more processors and a memory. The memory stores a database comprising a grasping point record for the object, said grasping point record containing:
database local descriptors and 2D-locations of features of the object; and
database 3D-location(s) of at least one grasping point of the object.
   The database may further comprise local reference frames and/or grasping patterns representing respectively the geometry of object at the grasping point(s), and trajectories which can be followed to come into contact with the object at the grasping point(s).

In addition, the memory stores instructions, which when executed by the one or more processors, cause the one or more processors to:
receive a scene image showing an object to be grasped in a scene;
based on the scene image:
   detect the object to be grasped and features of the object,
   determine local descriptors and 2D-locations of said features of the detected object;
based on the database, identify a matching set of at least eight pairs of local descriptors, each pair being composed of a selected local descriptor of the database and a corresponding selected local descriptor among the local descriptors determined at step S20, which pairs of local descriptors achieve best fit, i.e., minimize the cumulated distance in the feature space, between database local descriptors and determined local descriptors;
determine a registration which transforms the selected database local descriptors into the corresponding selected local descriptors;
determine in the scene image 2D-location(s) of at least one grasping point for the object by applying the registration to database 3D-location(s) of the at least one grasping points of the object;
determine 3D information relative to the object; and
determine 3D-location(s) of the at least one grasping point for the object, based on the 2D-location(s) of the at least one grasping point in the scene image determined at step S50 and the 3D information relative to the object.

In this method, at step S20, the instructions stored by the memory, when executed by the one or more processors, cause the one or more processors to identify the pairs of corresponding local descriptors using preferably the 8-point algorithm.

In an embodiment, the instructions stored by the memory, when executed by the one or more processors, cause the one or more processors to identify the pairs of corresponding local descriptors using successively the nearest neighborhood algorithm and the RANSAC method.

In an embodiment, the instructions stored by the memory, when executed by the one or more processors, cause the one or more processors to further determine a normal or a local reference frame, and/or a grasping pattern, at said at least one grasping point of the object.

In a particular implementation, the above-proposed methods are determined by computer program instructions.

Accordingly, another purpose the present disclosure is to propose a computer program which is stored on a computer readable storage media, and which is suitable for being performed on a computer, the program including instructions adapted to perform the steps of one of the above-proposed methods, when it is run on the computer.

The computer program is preferably stored on a non-transitory computer-readable storage media. The computer program may use any programming language, and be in the form of source code, object code, or code intermediate between source code and object code, such as in a partially compiled form, or in any other desirable form. The computer may be any data processing means, for instance a personal computer, an electronic control unit configured to be mounted in a car, etc.

The present disclosure also includes a computer-readable recording medium including instructions of the computer program defined above. The computer-readable medium may be any entity or device capable of storing the program. For example, the computer-readable medium may comprise storage means, such as a read only memory (ROM), e.g. a compact disk (CD) ROM, or a microelectronic circuit ROM, or indeed magnetic recording means, e.g. a floppy disk or a hard disk. Alternatively, the computer-readable medium may be an integrated circuit in which the program is incorporated, the circuit being adapted to execute or to be used in the execution of the control method in question.

### BRIEF DESCRIPTION OF THE DRAWINGS

The present invention may be better understood and its numerous other objects and advantages will become apparent to those skilled in the art by reference to the accompanying drawing wherein like reference numerals refer to like elements in the several figures and in which :

FIG. 1 is a figure showing a robot, as an example of a grasping points database creation system and a grasping points and grasping pattern determination system according to the present disclosure;

FIG. 2 is a schematic representation of the electronic control unit of the robot of FIG. 1;

FIG. 3 is a block diagram showing the steps of a grasping points database creation method, in an embodiment of the present disclosure;

FIG. 4 is a block diagram showing the steps of a grasping points determination method, in an embodiment of the present disclosure;

FIG. 5 is a schematic representation of an object whose grasping points have to be determined in order to create of record for the object in a database, placed on a stand to be photographed by the robot of FIG. 1;

FIG. 6 is a schematic representation of an image of the object of FIG. 5, showing local features detection;

FIG. 7 is a schematic representation of an image of the object of FIG. 6, when it is grasped by hand;

FIG. 8 is a schematic representation of an image of object whose grasping points have to be determined, showing features detection;

FIG. 9 is a schematic representation illustrating the identification of corresponding pairs of local descriptors of the database image of FIG. 6 and local descriptors of the current image of FIG. 8;

FIG. 10 is a schematic representation of the image of FIG. 8, showing a 3D-location, a local reference frame and a grasping pattern determined for a grasping point.

### DESCRIPTION OF THE PREFERRED EMBODIMENT

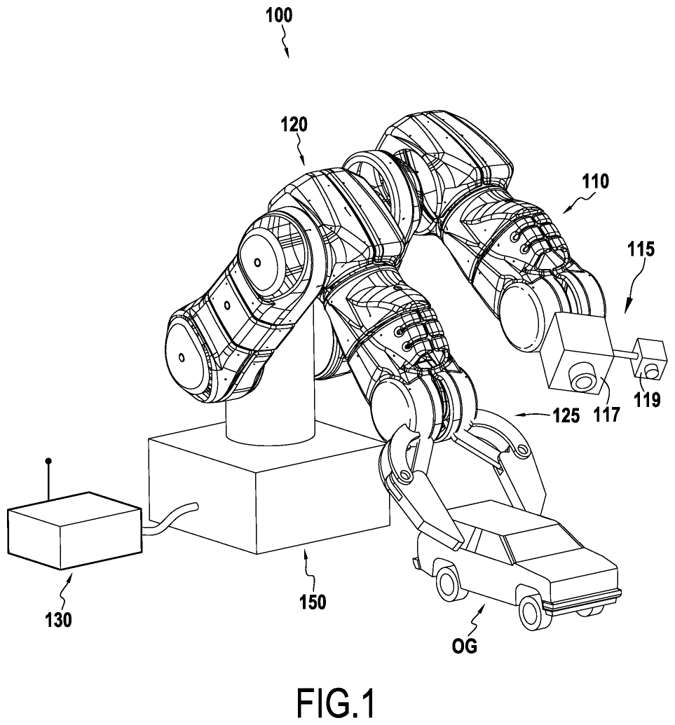

FIG. 1 shows a robot 100 used to grasp an object, and/or to acquire 2D and/or 3D information about objects. In the present case on FIG. 1, robot 100 is shown grasping a toy car OG.

The robot 100 is mounted on a stand 150. It includes a data acquisition arm 110, a grasping arm 120, and an electronic control unit (ECU) 130.

The data acquisition arm 110 has a 3D-scanner 115 mounted thereon.

3D-scanner 115 is a depth sensor, which comprises two cameras 117 and 119. It uses a stereovision algorithm to obtain depth information, and outputs a depth map which has the same resolution as the image of camera 117. Accordingly, for any image outputted by camera 117, 3D-scanner 115 can output a corresponding depth map containing a depth information (z) for each pixel of the image outputted by the camera.

Cameras 117 and 119 are regular CCD or CMOS camera. They can also be used just to acquire images of objects to be grasped, or whose grasping points have to be determined.

The grasping arm 120 has a claw 125 and is configured to grasp objects in the claw.

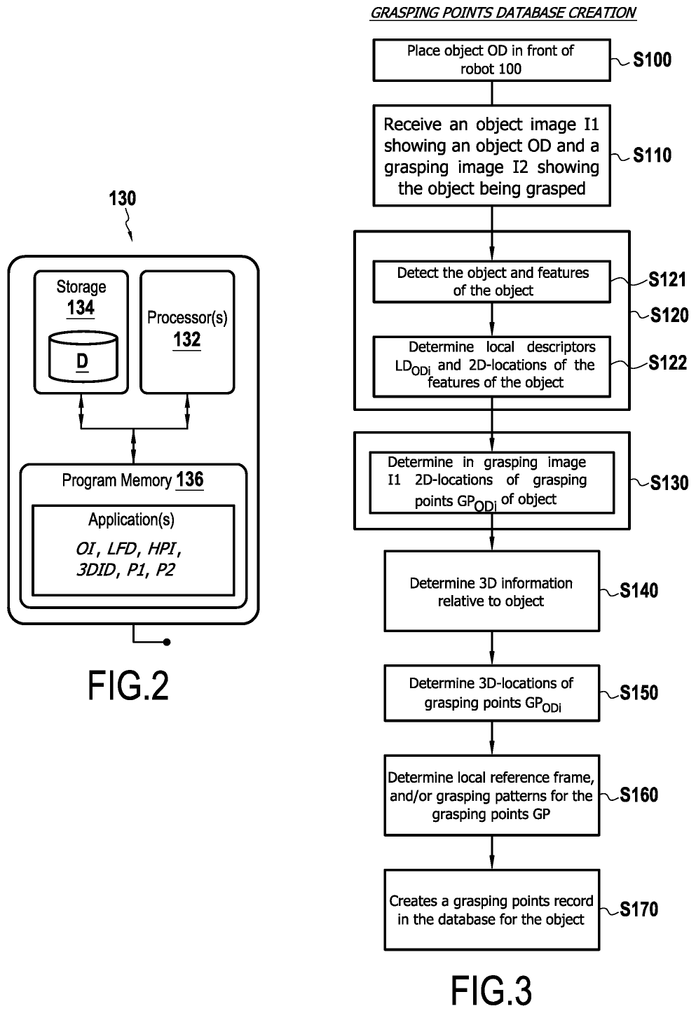

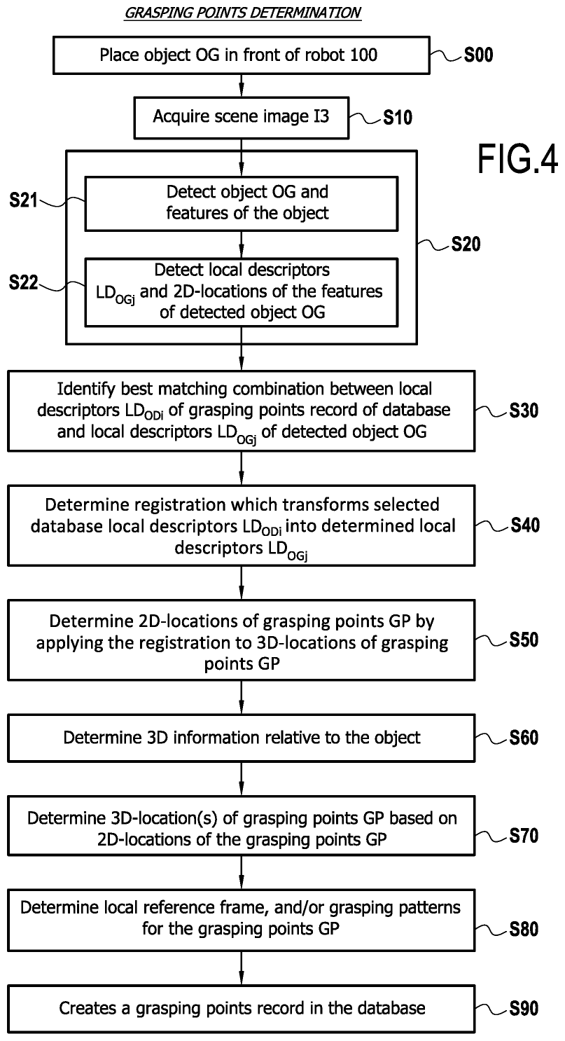

The material structure of the ECU 130 is illustrated by FIG. 2.

ECU 130 has the hardware architecture of a computer. ECU 130 comprises one or more processor(s) 132, a data memory or storage 134, a program memory 136. The data memory 134 comprises a database D which will be presented in detail below.

Program memory 136 comprises an operating system, and various applications.

These applications comprise in particular an object identification program OI, a local feature detection program LFD, a hand posture identification program HPI, and a 3D information determination program 3DID.

The object identification program OI is a program which can detect objects in one or more images. As known per se, this program can be for instance a deep neural network specially trained for object detection. Object identification program OI is capable of identifying (and in this case, has been trained to identify) the object(s) whose grasping point(s) are to be detected.

The object identification program OI can further detect the salient features of the object(s) detected in the image. In the present embodiment, for each feature, program OI returns the sub-image showing the detected feature.

In order to identify the features of the object in the images and calculate the local descriptors, the object identification program OI can rely on any suitable method: for instance Orb, Brisk, Kaze, etc. As known per se, this program can be for instance a deep neural network specially trained for features detection.

Once the features of an object have been detected, the local feature detection program LFD calculates the local descriptors for all the features that have been identified.

That is, for each feature identified by program OI, the local feature description program LFD calculates a local descriptor for this feature, and determines the 2D-location of this feature.

In this embodiment, the local descriptors calculated by program LFD are histograms showing intensity gradients in the sub-images showing the respective features. Of course, other types of local descriptors can be used to implement the proposed methods. For instance, the feature information can be information data determined by a neural network, etc.

The 2D-location of a feature as determined by program LFD is simply the 2D-location, in the image, of the center of the sub-image showing the feature; for instance, (u1,v1) for the first feature LD_{OD1} identified in image I1, (u2,v2) for the second feature LD_{OD2}, etc.

The hand posture identification program HPI is a program which can output, based on a grasping image showing a hand, a 3D-position of the hand in the image. The 3D-position of the hand as outputted by program HPI comprises in particular a set of line segments which correspond to the different finger portions of the fingers. The hand posture identification program is further configured to determine whether the hand is grasping an object and in this case, to determine the grasping points at which the hand is grasping the object.

The program HPI can for instance be based on the algorithm disclosed in publication “Learning joint reconstruction of hands and manipulated objects”, by Y. Hasson, G. Varol, D. Tzionas, I. Kalevatykh, M. Black, I. Laptev, C. Schmid, CVPR 2019.

The 3D information determination program 3DID is a program which can output 3D information relative to an object. Generally speaking such information can be normally a three-dimensional model of the object (or of a part of the object). 3D information relative to the object can thus be a cloud of 3D points (point defined by their 3D-coordinates), a mesh of triangles, etc.

In the present embodiment, the 3D information determination program 3DID is configured, based on a stereovision algorithm using a pair of images of cameras 117 and 119, to output a depth map of the part of the object which is visible in the images of both cameras 117 and 119. A depth map is defined herein as a set of 3D-coordinates organized spatially so as to form a matrix of 3D-points.

The depth map obtained in this manner constitutes the 3D-information on the object.

The applications contained in memory 136 of ECU 130 also comprise a computer program P1 which, based on the information outputted by programs OI, LD and HPI, can determine and store in the database D, the 2D- and 3D-locations, the local reference frame, the grasping pattern of the different grasping points GP identified for the object.

These applications also comprise a computer program P2 which can control robot 100, and process the image(s) outputted by camera 117, so as to identify the grasping points GP of an object placed in front of robot 100.

The execution of programs OI, LFD and 3DID is triggered by programs P1 and/or P2; consequently, these programs can be considered as being part of programs P1 and P2.

The programs P1 and P2, and the program memory 136, are examples respectively of computer programs and a computer-readable recording medium pursuant to the present disclosure. The memory 136 of ECU 50 indeed constitutes a recording medium according to the invention, readable by the processor(s) 132 and on which said programs P1 and P2 are recorded.

Two main functions of robot 100, which are performed by executing respectively programs P1 and P2, are now going to be presented:

(1) the creation of a database D of grasping points records, in which 2D- and 3D-locations of the grasping points of the object are recorded, along with local descriptors and 2D-locations of the features of the object in the image; and
(2) the determination of the respective locations, local reference frames and grasping patterns of the respective grasping points of the object, when robot 100 acquires an image in which the object can be detected.

### (1) Creation of a Database D of Grasping Points of an Object

When program P1 is executed, robot 100 is used as a grasping points and grasping pattern identification system.

In this mode of operation, robot 100 is used to build a database D containing information about the 3D-location, the local reference frame, the grasping pattern for each of the grasping points of the object.

The robot can be used to determine simultaneously such information for several objects identified in the image.

When the database has been completed, for each object OD recorded in the database, the database comprises a record containing:
a grasping point set comprising the grasping point(s) GP_{OD} for the object; and:
   for each feature among a plurality of features of the object: a 2D-location of the feature in an object image, a local descriptor describing the feature, and the sub-image showing the feature; and
   for each grasping point: its 3D-location, the local reference frame at the grasping point, and a grasping pattern at the grasping point.

Database D can be created by the robot 100 as follows (as an example, the procedure is presented in the case where the grasping points for a toy car OD have to be acquired):

For each object OD whose grasping points have to be recorded, the procedure comprises the following steps (FIG. 3):

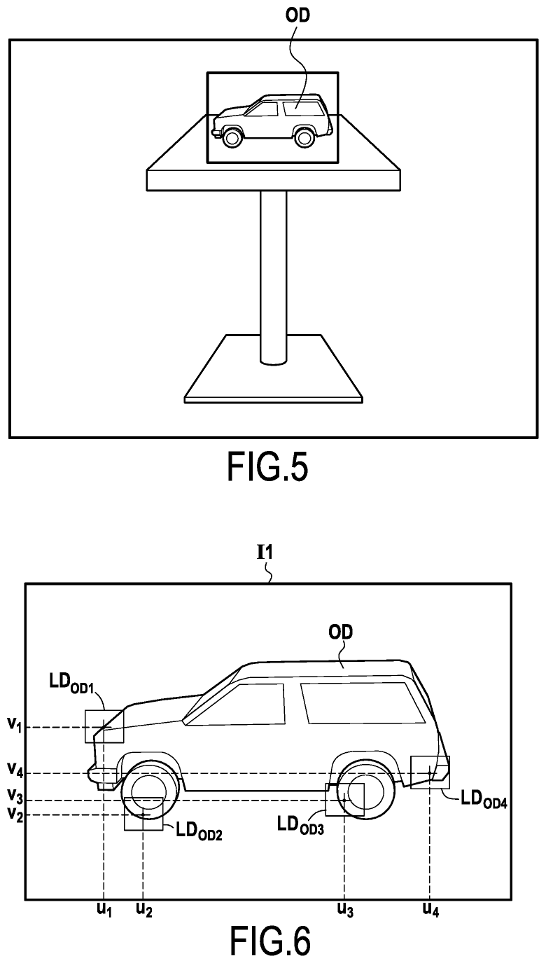

S100) First, the object is placed in front of robot 100. In the present case, toy car OD is placed on a stand in front of the robot (FIG. 5).
S110) Then, a picture I1 of the object is acquired by camera 10 (FIG. 6). This picture I1, which is the object image, shows the whole object, without any part of it being occluded.

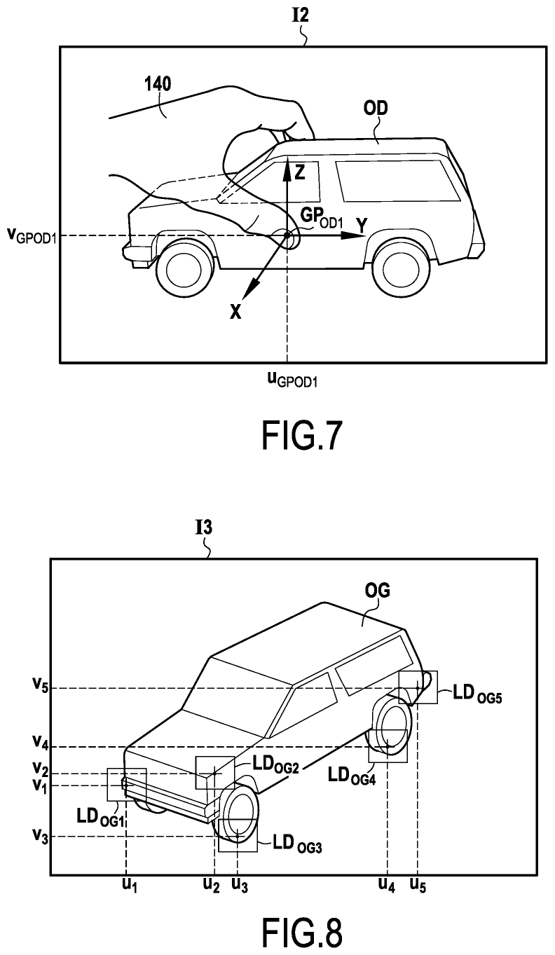

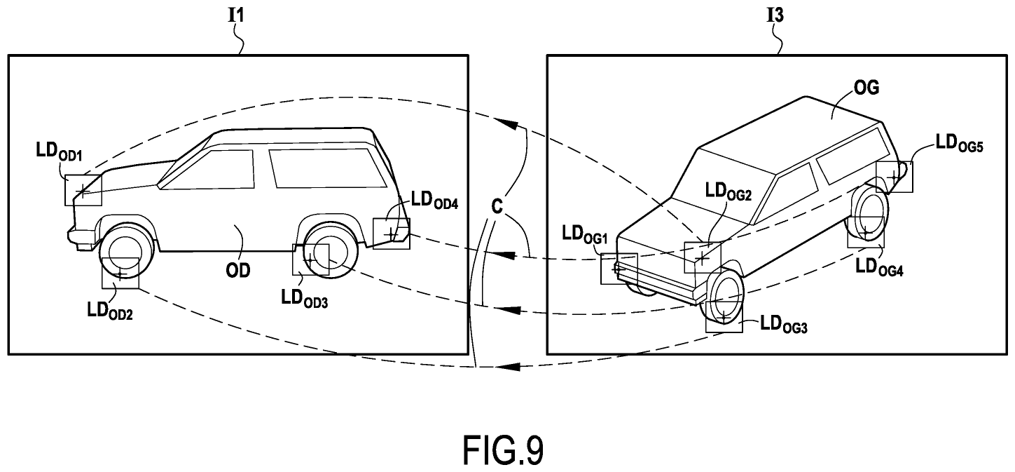

After that, the object OD is grasped by hand (hand 140 on FIG. 7). The position of hand 140 is chosen so that the hand is in contact with the object at a grasping point GP, which is convenient to grasp object OD. At this time, when hand 140 grasps the object, without moving, a grasping image I2 is acquired by camera 10. This image I2 shows the object OD and the hand 140 grasping the object, and is acquired from the same point of view relative to object OD as the object image I1.

The images I1 and I2 are transmitted to ECU 50.

S120) Then, the object OD and its most salient features, and then, for each feature, the 2D-location and the local descriptor describing or characterizing the feature, are determined by ECU 50 based on the object image I1. This determination is made by carrying out the following steps:
S121) First, using program OI, ECU 50 detects the objects which appear in the images I1,I2. In the present example, the program OI outputs the type (or identifier) of the detected object OD, and its bounding boxes in image I1.

The program OI further detects the salient features of the detected objects, and for each of these features, outputs the corresponding sub-image which shows the feature in image I1, and the 2D-location of the sub-image (its bounding-box).

It is assumed hereafter that only one object is detected (toy car OD); however, the procedure below is applicable in case several objects are detected simultaneously in image I1. In that case, the steps below are carried out in parallel, or at least separately, for each object detected in the images.

S122) Secondly, based on the object image I1 and using the local feature detection program LFD, for each feature of the detected object OD, ECU 50 calculates the local descriptor and the 2D-location of the feature of object OD. (FIG. 6).
S130) Then, based on the grasping image I2, ECU 50 determines the 2D-locations of the grasping point(s) by which the hand has grasped the object. In the present case, a single grasping point GP is identified.

In this purpose, using the hand posture identification program HPI, ECU 50 determines the position of the hand 140 grasping the object OD (FIG. 8) and on this basis, determines the 2D-location in image I2 of the grasping point GP. S140) Robot 100 determines a depth-map of a part of the object OD (as 3D-information relative to object OD). In this purpose, camera 119 also acquires a second object image I1′, in which the object is in the same position relative to the robot as in image I1. The depth image is calculated by stereovision on the basis of images I1 and I1′. Of course, the depth map only comprises the portion of the object which is visible in both images I1 and I1′.

S150) Then, based on this 3D information (the depth map), ECU 50 determines the 3D-location of the grasping point GP. This 3D-location is the position (x,y,z) of the point at the surface of the object which corresponds to the determined 2D-location in image I2 of grasping point GP.
S160) In addition, ECU 50 then determines the local reference frame at the grasping point GP. In this purpose, ECU 50 first calculates the normal vector X at point GP at the surface of the object, using the depth map of object OD. The ECU 50 then calculates a horizontal vector Y passing through point GP (the horizontal plane is known by robot 100, and thus the 3D-model of the object is referenced relative to the horizontal direction). Lastly, ECU 50 calculates the third vector Z of the local reference frame as the vector product of vectors X and Y.

In addition, a grasping pattern is calculated at the grasping point GP: ECU 50 determines a trajectory that can be used by a finger of claw 125 to come into contact with the object OD at the grasping point GP. The trajectory is such that when the finger of claw 125 finally touches object OD at the grasping point, the finger follows a trajectory perpendicular to the surface of the object OD at this point.

S170) Finally, ECU 50 creates a grasping points record in the database for each detected object: It stores in database D, for the detected object OD, a grasping points records which contains:
the grasping point set, comprising the 2D- and 3D-locations of the grasping point(s) GP detected for object OD; and
the local descriptors LD_{ODj} and the 2D-locations, detected for the all the detected features.

If the grasping points records for several different objects are to be recorded in database D, then the type of the object OD is further recorded in the grasping points record for the object.

In several objects are detected in the object image I1, the above operations (steps S110 to S170) are repeated for each detected object.

### (2) Determination of the Locations of the Grasping Points of an Object

Once database D has been created, the robot 100 can be used to determine the grasping points of the object, when the object is identified around the robot (i.e., when the object is identified in a scene image acquired by a camera of the robot, showing the scene surrounding the robot).

Of course, in order to determine the grasping points of an object, the database must contain the grasping points record for the object, acquired from a point of view which is similar to the point of view from which the object can be seen in the scene image.

In this case, the 3D-locations and the grasping patterns of the grasping points of an object can be determined with the following procedure:

(As an example, the procedure is presented below in the case where the object is the same toy car as in the previous mode of operation of the robot, now referenced OG (object to be grasped).

S00) First, the object (the toy car OG) is placed in front of robot 100 (FIG. 5).

If the database D contains a single grasping points record for the object, then at step SOO, the object must be placed in a position relative to camera 115 which is such that camera 115 is substantially at the same point of view relative to object OG as the point of view of this camera relative to the object in the grasping points record (a difference of up to about 30° can however be tolerated). The constraint is that, in the image acquired by camera 117, it must be possible to identify the features of object OD, as recorded in the grasping record object for object OG.

If conversely database D contains several grasping points records for the object, acquired from different points of view, then the object must be placed so that camera 115 be substantially at the same point of view relative to object OG as the point of view of this camera in one of these grasping points records.

Accordingly, if database D contains grasping points records for the object acquired from multiple points of view around the object, the object can be placed in front of the camera at step SOO in about any position.

S10) Then, a scene image I3 is acquired by camera 10, with the object OG clearly visible in the image(s). Image I3 is transmitted to ECU 50.

A pre-processing operation may be carried out beforehand to homogenize the scene image I3 with the object image I1 which was used to create the grasping point record for object OD.

S20) Then, the following operations are performed on images I3:
S21) First, using program OI, ECU 50 detects whether one or more objects are visible in images I3. In the present case, the toy car OG is detected in the scene image I3. The OI program outputs the type (or identifier) of the detected objects OG, and its bounding box BB_{OG} in image I3.

The program OI further detects the salient features of the detected object OG, and for each of these features, outputs the corresponding sub-image which shows the feature in image I3, and the 2D-location of the sub-image (its bounding-box).

It is assumed hereafter that only one object is detected (toy car OD); however, the procedure below is applicable in case several objects are detected simultaneously in images I1. In that case, the steps below are carried out in parallel, or at least separately, for each object detected in the images.

S22) Secondly, based on the scene image I3 and using the local feature detection program LFD, for each feature of the detected object OD, ECU 50 calculates the local descriptor and the 2D-location of the feature of object OG.

Program P2 then gets access in database D.

Program P2 determines which grasping points records of database D are related to object OG.

S30) Then, based on the grasping points records present in database D for object OG, ECU 50 determines the pairs of local descriptors which best correspond to each other. That is, ECU determines the pairs of local descriptors (each pair comprising a local descriptor recorder in a grasping points record of the object, and a local descriptor of af feature detected in image I3) which achieve best fit (i.e., minimal distance in the feature space).

More specifically, ECU determines a set of at least eight such pairs of local descriptors, which exhibit a high correspondence between the two members of the each pair, and which all belong to the same record of grasping points of the object (a record corresponding to a point of view of camera 117 relative to the object).

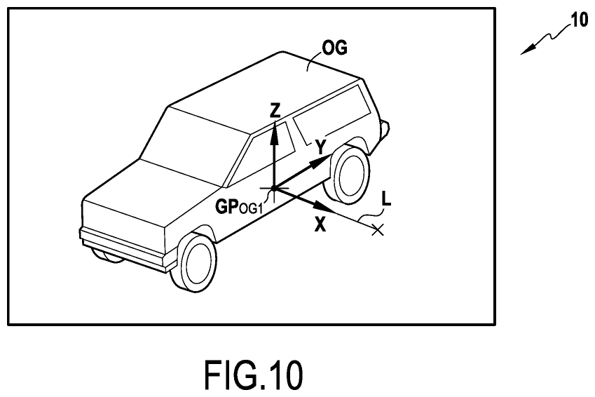

As shown by FIG. 10, the identified pairs of local descriptors associate a local descriptor LD_{ODI} recorded in the grasping points record of object OD, and a corresponding selected local descriptors DLD_{OGj}, selected among the local descriptors determined in the scene image I3 (i,j are indices respectively of the local descriptors of the grasping points record and of the detected local descriptors).

As explained above, the pairs of local descriptors are determined by program P2 by executing a nearest neighborhood method, and then by applying a RANSAC method.

S40) Then, the registration is determined, which transforms, for each pair of local descriptors identified at step S30, the selected database local descriptor LD_{ODi} into the corresponding selected local descriptor LD_{OGj}.
S50) Then, the 2D-location of the grasping point GP of the object is determined in the scene image I3. This 2D-location is determined by applying the registration determined at step S40 to the 3D-location of the grasping point GP of the object, as recorded in database D. This transformation outputs a 3D-location in the coordinate system of camera 117 (in the point of view of image scene I3); this 3D-location is then transformed into a 2D-location in the scene image I3 by ignoring z, and using the 2D coordinates in image I3 only.
S60) Then, as in step S140, robot 100 determines the depth-map of the object OD which is visible in image I3, using the 3D-scanner 115.
S70) Then ECU 50 determines the 3D-location of grasping point GP of object OG. This 3D-location is the position (x,y,z) of the point at the surface of the object which corresponds to the 2D-location of grasping point GP determined at step S50.
S80) In addition, ECU 50 then determines the local reference frame and a grasping pattern (L, FIG. 10) at the grasping point GP. The local reference frame and the grasping pattern are obtained by applying the registration determined at step S40 to the local reference frame and a grasping pattern of the grasping point, as recorded in the grasping points record of the object, in database D.
S90) Then, ECU 50 creates a grasping points record in the database for object OG, and stores in database D, a grasping points record which contains:
the grasping point set, comprising the 2D- and 3D-locations, the local reference frame and the grasping pattern of the grasping point GP detected for object OG; and
the local descriptors LD_{OGj} and the 2D-locations for all the detected features.

If grasping points records for several different objects are to be recorded in database D, then the type of the object OD is further recorded in the grasping points record for the object.

In several objects are detected in the scene image I3, the above operations (steps S10 to S90) are repeated for each object.

1-14. (canceled)

15. A grasping points database creation method, the method comprising:
S110) receiving an object image showing an object;
receiving a grasping image showing the object being grasped at at least one grasping point;
the object image and the grasping image being acquired from the same point of view relative to the object;
S120) based on the object image:
detecting the object and features of the object,
determining local descriptors and 2D-locations of said features of the detected object;
S130) determining in the grasping image 2D-location(s) of said at least one grasping point of the detected object;
S140) determining 3D information relative to the object;
S150) determining 3D-location(s) of the at least one grasping point for the object, based on the 2D-location(s) of the at least one grasping point determined at step S130 and the 3D information relative to the object; and
S170) storing in the database a grasping points record relative to the object, comprising the determined local descriptors and the determined 2D-locations of the features of the detected object, and the 2D- and/or 3D-location(s) of the at least one grasping point for the object.

16. The grasping points determination method according to claim 15, further comprising a step S160 wherein a normal, a local reference frame, and/or a grasping pattern of said at least one grasping point of the object is or are determined.

17. The grasping points determination method according to claim 15, wherein the grasping image shows a hand grasping the objects; and at step S130, the 2D-location(s) of said at least one grasping point of the detected object are determined by determining a pose of the hand.

18. The grasping points determination method according to claim 16, wherein the grasping image shows a hand grasping the objects; and at step S130, the 2D-location(s) of said at least one grasping point of the detected object are determined by determining a pose of the hand.

19. A grasping points database creation system comprising one or more processors and a memory;
the memory storing instructions, which when executed by the one or more processors, cause the at least one processor to:
receive an object image showing an object;
receive a grasping image showing the object being grasped at at least one grasping point;
the object image and the grasping image being acquired from the same point of view relative to the object;
based on the object image:
detect the object and features of the object, and
determine local descriptors and 2D-locations of said features of the detected object;
determine in the grasping image 2D-location(s) of said at least one grasping point of the detected object;
determine 3D information relative to the object ;
determine 3D-location(s) of the at least one grasping point for the object, based on the 2D-location(s) of the at least one grasping point determined at step S130 and the 3D information relative to the object; and
store in the database a grasping points record relative to the object, comprising the determined local descriptors and the determined 2D-locations of the features of the detected object, and the 2D- and/or 3D-location(s) of the at least one grasping point for the object.

20. The grasping points database creation system according to claim 19, wherein said instructions, when executed by the at least one processor, cause the system to determine a normal, a local reference frame, and/or a grasping pattern, of said at least one grasping point of the object.

21. The grasping points database creation system according to claim 19, wherein said instructions, when executed by the at least one processor, and when the grasping image shows a hand grasping the objects, cause the system to determine the 2D-location(s) of said at least one grasping point of the detected object by determining a pose of the hand.

22. The grasping points database creation system according to claim 20, wherein said instructions, when executed by the at least one processor, and when the grasping image shows a hand grasping the objects, cause the system to determine the 2D-location(s) of said at least one grasping point of the detected object by determining a pose of the hand.

23. A grasping points determination method comprising:
S10) receiving a scene image showing an object to be grasped in a scene;
S20) based on the scene image:
detecting the object to be grasped and features of the object;
determining local descriptors and 2D-locations of said features of the detected object;
S30) based on a database comprising a grasping point record for the object, said grasping point record containing:
database local descriptors and 2D-locations of features of the object; and
database 3D-location(s) of at least one grasping point of the object,
identifying at least eight pairs of local descriptors, each pair being composed of a selected local descriptor of the database and a corresponding selected local descriptor among the local descriptors determined at step S20, for which a distance between a database local descriptor and a determined local descriptor is minimal;
S40) determining a registration which transforms the selected database local descriptors into the corresponding selected local descriptors;
S50) determining in the scene image 2D-location(s) of at least one grasping point for the object by applying the registration to database 3D-location(s) of the at least one grasping points of the object;
S60) determining 3D information relative to the object;
S70) determining 3D-location(s) of the at least one grasping point for the object, based on the 2D-location(s) of the at least one grasping point in the scene image determined at step S50 and the 3D information relative to the object.

24. The grasping points determination method according to claim 23, wherein the pairs of corresponding local descriptors are identified at step S30 using successively the nearest neighbourhood algorithm and the RANSAC method.

25. The grasping points determination method according to claim 23, further comprising at a step S70, determining a normal or a local reference frame, and/or a grasping pattern, of said at least one grasping point of the object.

26. The grasping points determination method according to claim 24, further comprising at a step S70, determining a normal or a local reference frame, and/or a grasping pattern, of said at least one grasping point of the object.

27. A grasping points determination system for determining 3D-locations of grasping points of an object; the system comprising one or more processors and a memory;
the memory storing a database comprising a grasping point record for the object, said a grasping point record containing:
database local descriptors and 2D-locations of features of the object; and
database 3D-location(s) of at least one grasping point of the object,
the memory storing instructions, which when executed by the one or more processors, cause the one or more processors to:
receive a scene image showing an object to be grasped in a scene;
based on the scene image:
detect the object to be grasped and features of the object,
determine local descriptors and 2D-locations of said features of the detected object;
based on the database, identify at least eight pairs of local descriptors, each pair being composed of a selected local descriptor of the database and a corresponding selected local descriptor among the local descriptors determined at step S20, for which a distance between a database local descriptor and a determined local descriptor is minimal;
determine a registration which transforms the selected database local descriptors into the corresponding selected local descriptors;
determine in the scene image 2D-location(s) of at least one grasping point for the object by applying the registration to database 3D-location(s) of the at least one grasping points of the object;
determine 3D information relative to the object ; and
determine 3D-location(s) of the at least one grasping point for the object, based on the 2D-location(s) of the at least one grasping point in the scene image determined at step S50 and the 3D information relative to the object.

28. The grasping points determination system according to claim 27, wherein the instructions stored by the memory, when executed by the one or more processors, cause the one or more processors to identify the pairs of corresponding local descriptors using successively the nearest neighborhood algorithm and the RANSAC method.

29. The grasping points determination system according to claim 27, wherein the instructions stored by the memory, when executed by the one or more processors, cause the one or more processors to further determine a normal or a local reference frame, and/or a grasping pattern, at said at least one grasping point of the object.

30. The grasping points determination system according to claim 28, wherein the instructions stored by the memory, when executed by the one or more processors, cause the one or more processors to further determine a normal or a local reference frame, and/or a grasping pattern, at said at least one grasping point of the object.

31. A computer program which is stored on a computer readable storage media, and which is suitable for being performed on a computer, the program including instructions adapted to perform the steps of a method according to claim 15, when it is run on the computer.

32. A computer-readable recording medium including instructions of a computer program according to claim 31.
